(19) United States
(12) Patent Application Publication
(10) Pub. No.: US 2024/0323825 A1
(43) Pub. Date: Sep. 26, 2024

(54) SELECTING A NON-3GPP ACCESS NETWORK

(71) Applicant: Lenovo (Singapore) Pte. Ltd., New Tech Park (SG)

(72) Inventors: Apostolis Salkintzis, Athens (GR); Dimitrios Karampatsis, Ruislip (GB); Roozbeh Atarius, La Jolla, CA (US)

(21) Appl. No.: 18/574,269

(22) PCT Filed: Aug. 3, 2021
(86) PCT No.: PCT/EP2021/071704

§ 371 Date: Dec. 26, 2023

(30) Foreign Application Priority Data
Jun. 24, 2021 (GR) 20210100418

(51) Int. Cl. H04W 48/18; H04W 76/10; H04W 84/12

(52) U.S. Cl. CPC H04W 48/18; H04W 76/10; H04W 84/12

(57) ABSTRACT

Apparatuses, methods, and systems are disclosed for WLAN access network selection. One apparatus includes a transceiver and a processor that identifies a first data flow that matches a first URSP rule. Here, the first URSP rule indicates that the first data flow is to be transmitted over a N3AN, where the first URSP rule contains a reference to a first rule. The processor selects a first N3AN by applying the first WLANSP rule. The transceiver transmits the first data flow via the selected N3AN.

### FIELD

The subject matter disclosed herein relates generally to wireless communications and more particularly relates to non-3GPP access network selection using User Equipment (“UE”) route selection policy (“URSP”) rules and Wireless Local Area Network Selection Policy (“WLANSP”).

### BACKGROUND

3GPP standards organization has defined in 3GPP TS 24.526, 3GPP TS 23.503 and 3GPP TS 24.501, how the network can create and transmit a set of policies to a UE to connect to a non-3GPP network which may be trusted or untrusted. The PLMN policy for a UE is sent to the UE as UE route selection policy (“URSP”) rules or for the untrusted non-3GPP access network discovery and selection policy (“ANDSP”). The URSP has information about route selection descriptor (“RSD”) and traffic descriptor, while the ANDSP has information about WLAN selection policy (“WLANSP”) and non-3GPP access network (“N3AN”) rule for accessing the untrusted non-3GPP network.

Currently when the UE connects to a non-3GPP network, the assumptions is that a non-3GPP access network supports all the S-NSSAIs, however this assumption may not be correct. Therefore, it should be considered how a UE selects a non-3GPP access network that can support a specific S-NSSAI.

### BRIEF SUMMARY

Disclosed are procedures for WLAN access network selection. Said procedures may be implemented by apparatus, systems, methods, and/or computer program products.

One method of a User Equipment (“UE”) includes identifying a first data flow that matches a first UE Route Selection Policy (“URSP”) rule. Here, the first URSP rule indicates that the first data flow is to be transmitted over a (“N3AN”), the first URSP rule containing a reference to a first Wireless Local Area Network Selection Policy (“WLANSP”) rule. The method includes selecting a first N3AN by applying the first WLANSP rule and transmitting the first data flow via the selected N3 AN.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for WLAN access network selection;

FIG. 2 is a diagram illustrating one embodiment of a procedure for receiving a UE policy;

FIG. 3 is a diagram illustrating one embodiment of URSP rules that reference WLANSP rules;

FIG. 4 is a signal flow diagram illustrating one embodiment of a procedure for PDU session establishment by using an URSP rule that references a WLANSP rule;

FIG. 5 is a block diagram illustrating one embodiment of a user equipment apparatus that may be used for WLAN access network selection;

FIG. 6 is a block diagram illustrating one embodiment of a network apparatus that may be used for WLAN access network selection; and

FIG. 7 is a flowchart diagram illustrating one embodiment of a method for WLAN access network selection.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for WLAN access network selection. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

3GPP standards organization has defined in 3GPP TS 24.526, 3GPP TS 23.503 and 3GPP TS 24.501, how the network can create and transmit a set of policies to a UE to connect to a non-3GPP network which may be trusted or untrusted. The PLMN policy for a UE is sent to the UE as UE route selection policy (“URSP”) rules or for the untrusted non-3GPP access network discovery and selection policy (“ANDSP”). The URSP has information about route selection descriptor (“RSD”) and traffic descriptor, while the ANDSP has information about WLAN selection policy (“WLANSP”) and non-3GPP access network (“N3AN”) rule for accessing the untrusted non-3GPP network.

The route selection descriptors (“RSDs”) are described in 3GPP TS 24.526 and comprise components such as types for session and service continuity (“SSC”) mode, single network slice selection assistance information (“S-NSSAI”), data network name (“DNN”), packet data unit (“PDU”) session type, preferred access type, multi-access preference, non-seamless non-3GPP offload indication, location criteria and time window.

The traffic descriptors are described in 3GPP TS 24.526 and comprises components such as types for match-all, Operating System Identity (“OS Id”) plus Operating System Application Identity (“OS App Id”), IPv4 remote address, IPv6 remote address/prefix length, protocol identifier/next header, single remote port, remote port range, Internet Protocol (“IP”) 3 tuple, security parameter index, type of service/traffic class, flow label, destination Medium Access Control (“MAC”) address, 802.1Q customer tag (“C-TAG”) virtual local area network Identifier (“VID”), 802.1Q service tag (“S-TAG”) VID, 802.1Q C-TAG Priority Code Point/Drop Eligible Indicator (“PCP/DEI”), 802.1Q S-TAG PCP/DEI, ethertype, Data Network Name (“DNN”), connection capabilities type, destination Fully Qualified Domain Name (“FQDN”), regular expression, OS App Id.

The relationship between the route selection descriptors and the traffic descriptor may be many-to-one; meaning one or more route selection descriptors and one traffic descriptor may be in in one URSP rule.

Based on the current 3GPP specifications, a 5G UE selects a WLAN access network as follows:
a. If the UE wants to select a WLAN access network in order to directly offload specific traffic to this access network, the UE performs the selection by applying the Wireless Local Area Network Selection Policy (WLANSP) rules provisioned in the UE.
b. If the UE wants to select a WLAN access network in order to register with a PLMN using the trusted 5G registration procedure, the UE first discovers the WLAN access networks that support 5G connectivity with this PLMN and then applies the WLANSP rules to select one of these WLAN access networks.
c. If the UE wants to select a WLAN access network in order to register with a PLMN using the untrusted 5G registration procedure, the UE performs the selection by applying the WLANSP rules to select one of these WLAN access networks.

Each WLANSP rule contains a prioritized list of selection criteria groups, and each group identifies certain capabilities or properties that a WLAN access network must support in order to match this selection criteria group. The UE may use the Access Network Query Protocol (“ANQP”) is a query and response protocol that to discover WLAN AN capabilities and services offered by a WLAN access point (“AP”). A WLANSP rule may also contain validity conditions, such as a day of time and/or a location in which the rule is valid.

When the UE applies the WLANSP rules for selecting a WLAN access network, the UE first identifies the so-called Active WLANSP rule (i.e., the highest-priority valid WLANSP rule) and then applies the selection criteria in this rule (in priority order) for selecting a WLAN access network.

Note that the Active WLANSP rule (i.e., the rule applied to select a WLAN access network) is determined primarily based on the time of day and location conditions. So, a different WLAN access network may be selected in different times of day or in different locations. However, it is not possible to select a different WLAN access network based on more advanced conditions, i.e., based on why the WLAN connection is needed, such as network slice support.

The purpose of this disclosure is to specify enhancements to the WLAN selection procedure, which support more advanced WLAN selection scenarios, such as those mentioned above.

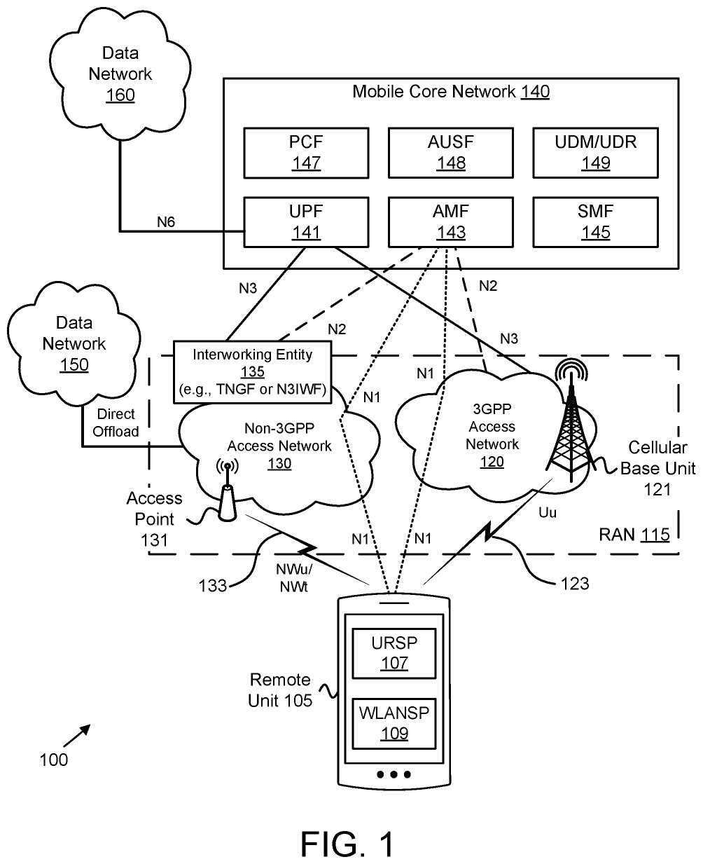

In one embodiment, the wireless communication system 100 includes at least one remote unit 105, a Radio Access Network (“RAN”) 115, and a mobile core network 140. The RAN 115 and the mobile core network 140 form a mobile communication network. The RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 115 is compliant with the Fifth-Generation (“5G”) system specified in the Third Generation Partnership Project (“3GPP”) specifications. For example, the RAN 115 may be a New Generation Radio Access Network (“NG-RAN”), implementing New Radio (“NR”) Radio Access Technology (“RAT”) and/or Long-Term Evolution (“LTE”) RAT. In another example, the RAN 115 may include non-3GPP RAT (e.g., Wi-Fi® or Institute of Electrical and Electronics Engineers (“IEEE”) 802.11-family compliant WLAN). In another implementation, the RAN 115 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 160) via a network connection with the mobile core network 140. For example, an application (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In other embodiments, a remote unit 105 may establish a connection with an entity in the data network 150 for direct offload of certain traffic. For example, the data network 150 may be an edge computing network, having local instances of one or more application servers. Here, a corresponding application client in the remote unit 105 may establish a connection with a local application server in the data network 150. As discussed in greater detail below, a URSP rule in the remote unit 105 may indicate that certain traffic is to be directly offloaded to the data network 150 rather than transferred via PDU session.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network.

In certain embodiments, a non-3GPP access network 130 may be controlled by an operator of the mobile core network 140 and may contain an interworking function that provides direct access to the mobile core network 140. Such a non-3GPP access network deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP access network deployment that is not controlled by an operator (or trusted partner) of the mobile core network 140, does not have direct access to the mobile core network 140, or does not support the certain security features is referred to as a “untrusted” non-3GPP access network. An interworking entity 135 deployed in a trusted non-3GPP access network 130 may be referred to herein as a Trusted Network Gateway Function (“TNGF”). An interworking entity 135 deployed to support interworking with an untrusted non-3GPP access network 130 may be referred to herein as a non-3GPP interworking function (“N3IWF”). Note that the N3IWF is not part of the untrusted non-3GPP access network.

In one embodiment, the mobile core network 140 is a 5G core network (i.e., “5GC”) or an Evolved Packet Core (“EPC”) networks, which may be coupled to the packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the 5G-RAN 115, a Session and Mobility Management Function (“SMF”) 145, a Policy Control Function (“PCF”) 147, an Authentication Server Function (“AUSF”) 148, a Unified Data Management function (“UDM”) and a User Data Repository (“UDR”).

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The AUSF 148 acts as an authentication server and allows the AMF 143 to authenticate the remote unit 105. The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides NF service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC. In certain embodiments, the mobile core network 140 may include an authentication, authorization, and accounting (“AAA”) server.

In various embodiments, the each of the mobile core network 140 supports different types of mobile data connections and different types of network slices, wherein each mobile data connection utilizes a specific network slice. Here, a “network slice” refers to a portion of a core network optimized for a certain traffic type or communication service. A network slice instance may be identified by a single-network slice selection assistance information (“S-NSSAI”) while a set of network slices for which the remote unit 105 is authorized to use may be identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140.

While FIG. 1 depicts components of a 5G RAN and a 5G core network, the described embodiments for establishing multiple concurrent registrations with a mobile network apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The RAN 115 refers to any type of 5G access network that can provide access to the mobile core network 140, including the 3GPP access network 120 and the non-3GPP access network 130.

When the remote unit 105 selects WLAN access network 140, the remote unit 105 sends data traffic to the Data Network 160 via a PDU Session established in the mobile core network 140. The traffic over this PDU Session traverses the WLAN access network 160, the interworking entity 135 and the UPF 141. When the remote unit 105 selects the WLAN access network 130, the remote unit 105 sends data traffic to the Data Network 150 directly via the WLAN access network 130 (or the remote unit 105 offloads selected data traffic directly to the WLAN access network, without going through the mobile core network 140.

For selecting a specific access network, a remote unit 105 may be configured with at least a URSP 107 and a WLANSP 109. The solutions specified in this disclosure describe how the remote unit 105 selects a WLAN access network depending on what type of ‘route’ the remote unit 105 needs to establish via this WLAN access network.

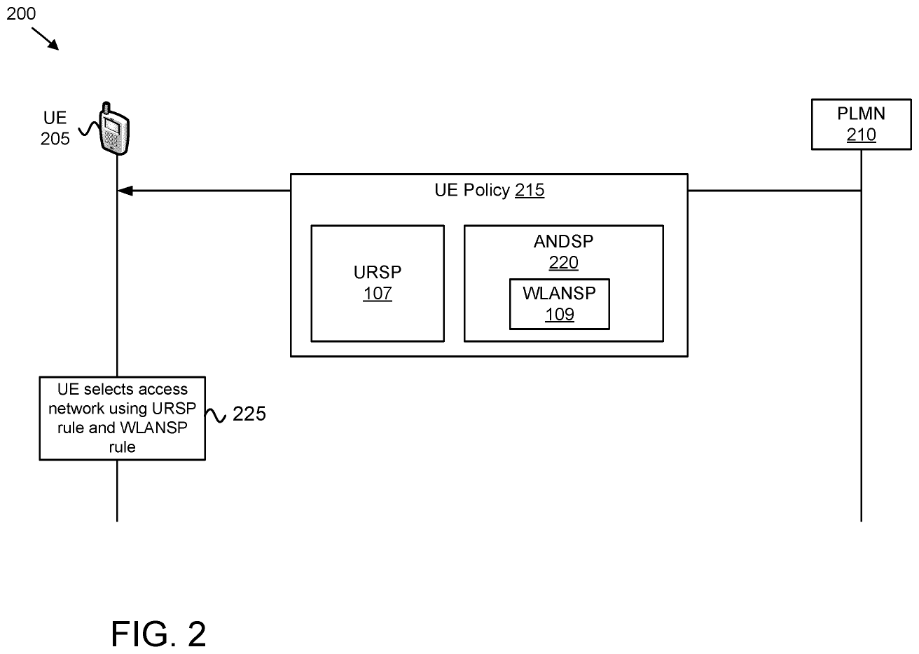

FIG. 2 depicts an example procedure 200 of UE Policy Configuration, according to embodiments of the disclosure. The procedure 200 involves the UE 205 and a PLMN 210. The UE 205 may be one embodiment of the remote unit 105, while the PLMN 210 may be one embodiment of the mobile network 140, described above. The PLMN 210 generates a UE policy 215 based on subscription data of the UE 205.

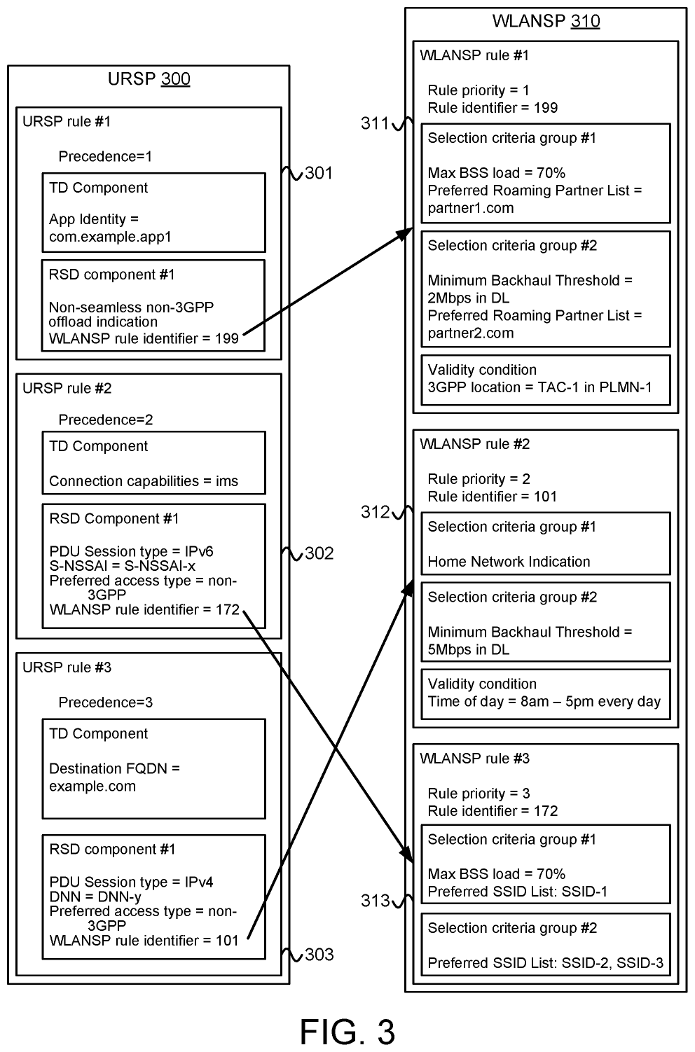

The UE policy 215 includes a UE Route Selection Policy (“URSP”) 107 and an Access Network Discovery and Selection Policy (“ANDSP”) 220. The ANDSP 220 includes a WLAN Selection Policy (“WLANSP”) 109. The UE policy 215 includes correspondence information that correlates a USRP rule to a WLANSP rule, as described in greater detail below with reference to FIG. 3. The UE 205 may use a combination of URSP rule and WLANSP rule to select a WLAN access network using advanced conditions, i.e., based on why the WLAN connection is needed, such as network slice support (see block 225).

FIG. 3 depicts an example list of USRP and WLANSP rules, according to embodiments of the disclosure. The depicted URSP and WLANSP may be embodiments of the URSP 107 and WLANSP 109, described above. These policies may be configured at a UE 205 (i.e., an implementation of the remote unit 105) by a mobile network operator, such as the HPLMN operator and/or VPLMN operator. The depicted URSP 300 includes at least a first URSP rule (i.e., URSP rule #1) 301, a second URSP rule (i.e., URSP rule #2) 302, and a third URSP rule (i.e., URSP rule #3) 303. Note that in other implementations, the URSP 300 may include additional and/or different URSP rules. In the depicted embodiment, the URSP rules 301-303 are listed in order of precedence (i.e., in priority order starting with a highest priority URSP rule). However, in other embodiments the URSP rules 301-303 are not listed in order of precedence.

In addition to the aforementioned WLANSP rules, the UE 205 may also be provisioned with UE Route Selection Policy (“URSP”) rules. These rules are applied by the UE 205 when it wants to select a ‘route’ for specific traffic. If this route does not exist, the UE 205 triggers procedures for the establishment of the route.

An example set of URSP rules provisioned in the UE 205 are depicted below.

The first URSP rule 301 indicates that the traffic matching the Traffic Descriptor (“TD”) component of this rule (i.e., all traffic originated by the app with identity com.example.app1), must be offloaded directly to a non-3GPP access network, typically to a WLAN access network. When the UE 205 attempts to transmit traffic that matches the first URSP rule 301 rule, the UE 205 will first select and connect to a WLAN access network and then will offload this traffic directly to the WLAN access network.

The second URSP rule 302 indicates that the traffic matching the Traffic Descriptor (“TD”) component of this rule (i.e., all traffic with IMS connection capabilities), is to be sent via PDU session where the preferred access type is non-3GPP access. When the UE 205 attempts to transmit traffic that matches the second URSP rule 302, the UE 205 will first select and connect to a WLAN access network and then will establish a PDU session according to the Route Selection Descriptor (“RSD”) component.

The third URSP rule indicates that the traffic matching the Traffic Descriptor (“TD”) component of this rule (i.e., all traffic with destination Fully Qualified Domain Name (“FQDN”)=example.com), is to be sent via PDU session where the preferred access type is non-3GPP access. Alternatively, the TD may reference a Data Network Name (“DNN”). When the UE 205 attempts to transmit traffic that matches this rule, the UE 205 will first select and connect to a WLAN access network and then will offload this traffic directly to the WLAN access network. Hence, the URSP rules can trigger WLAN selection, which involves the application of WLANSP rules.

The depicted WLANSP 310 includes at least a first WLANSP rule (i.e., WLANSP rule #1) 311, a second WLANSP rule (i.e., WLANSP rule #2) 312, and a third WLANSP rule (i.e., WLANSP rule #3) 303. Note that in other implementations, the WLANSP 310 may include additional and/or different WLANSP rules. In the depicted embodiment, the WLANSP rules 301-303 are listed in order of precedence (i.e., in priority order starting with a highest priority WLANSP rule). However, in other embodiments the WLANSP rules 311-313 are not listed in order of precedence.

Each WLANSP rule 311-313 contains a prioritized list of selection criteria groups. Here, each selection criteria group identifies certain capabilities or properties that a WLAN access network must support in order to match this selection criteria. In certain embodiments, a WLANSP rule may also contain validity conditions, such as a time-of-day and/or a location in which the rule is valid. In the depicted embodiment, the first WLANSP rule 311 includes a location-based validity condition (i.e., 3GPP location=TAC-1 in PLMN-1) and the second WLANSP rule 312 includes a time-of-day validity condition (i.e., Time of day=8 am to 5 pm every day).

When the UE 205 applies the WLANSP rules for selecting a WLAN access network, the UE 205 first identifies the so-called Active WLANSP rule (i.e., the highest-priority valid WLANSP rule). Next, the UE 205 applies the selection criteria in this rule (in priority order) for selecting a WLAN access network.

For example, where the second WLANSP rule 312 is the active WLANSP rule, the UE 205 attempts to select a WLAN access network that supports interworking with the home PLMN, based on the “home network indication” in the first selection criteria group. If no such WLAN access network is available, the UE 205 attempts to select a WLAN access network that support at least 5 Mbps downlink (“DL”) throughput in the backhaul link, i.e., based on parameters the second selection criteria group.

As described above, the conventional solution does not support the selection of a WLAN access network based on advanced conditions. Therefore, the WLAN access network selection is inefficient, and problematic is several scenarios. For example, in the scenario where a WLAN access network is configured to support connectivity only to one network slice in a PLMN, the conventional solution may select a WLAN access network that does not support connectivity to the network slice required by the UE 205.

Using current WLANSP rule scheme, the Active WLANSP rule (i.e., the rule applied to select a WLAN access network) is determined primarily based on the time of day and location conditions. Additionally, a different WLAN access network may be selected in different times of day or in different locations. However, the structure of the WLANSP rule does not allow selection of a WLAN access network based on more advanced conditions. For example, the following scenarios cannot be supported:

Scenario A: Select a WLAN access network based on the traffic that should be offloaded to this WLAN access network. In this scenario, the WLANSP rule does not support the following selection example: “If a WLAN access network is needed to directly offload the traffic of App-1, then select a WLAN access network using a first set of selection criteria. However, if a WLAN access network is needed to directly offload the traffic of App-2, then select a WLAN access network using a second set of selection criteria.”

Scenario B: Select a WLAN access network based on the network slice to which connectivity should be obtained. In this scenario, the WLANSP rule does not support the following selection example: “If a WLAN access network is needed to establish connectivity to network slice X of PLMN-1, then select a WLAN access network using a first set of selection criteria. However, if a WLAN access network is needed to establish connectivity to network slice Y of PLMN-1, then select a WLAN access network using a second set of selection criteria.”

Scenario C: Select a WLAN access network based on the DNN to which connectivity should be obtained. In this scenario, the WLANSP rule does not support the following selection example: “If a WLAN access network is needed to establish connectivity to DNN-x, then select a WLAN access network using a first set of selection criteria. However, if a WLAN access network is needed to establish connectivity to DNN-y, then select a WLAN access network using a second set of selection criteria.”

Scenario D: Select a WLAN access network based on the Connection Capabilities that should be supported. In this scenario, the WLANSP rule does not support the following selection example: “If a WLAN access network is needed to support IMS connectivity (Connection Capabilities=IMS), then select a WLAN access network using a first set of selection criteria. However, if a WLAN access network is needed to support Internet connectivity (Connection Capabilities=Internet), then select a WLAN access network using a second set of selection criteria.”

A common feature of the URSP rules and the WLANSP rules is that both are applied for making a selection:
The URSP rules are applied for selecting a ‘route’ that should be used for specific traffic; and
The WLANSP rules are applied for selecting a WLAN access network.

Apart from that, however, the URSP rules and the WLANSP rules are different and independent.

Disclosed herein are enhancements to the WLAN selection procedure, to support more advanced WLAN selection scenarios, such as those mentioned above. Of particular importance is Scenario B, because a WLAN access network may be configured to support connectivity only to one network slice in a PLMN. So, when the UE 205 wants to select a WLAN access network in order to establish connectivity to a particular network slice in a PLMN, it is important that the UE 205 applies a WLANSP rule that can select WLAN access networks that supports connectivity to this network slice.

The solution proposed in this disclosure for advanced WLAN access network selection is based on updating the URSP rules so that they can reference specific WLANSP rules. This solution is schematically illustrated below. Note that the Route Selection Description component of a URSP rule is updated to contain a WLANSP rule identifier, which refers to a specific WLANSP rule.

The updated URSP rules shown in FIG. 3 are interpreted as follows:

Regarding the first URSP rule 301: The traffic that matches the Traffic Descriptor component of this rule should be directly offloaded to a non-3GPP access network (e.g., a WLAN access network). Here, the non-3GPP access network should be selected using the WLANSP rule with Rule identifier=199, i.e., the first WLANSP rule 311. Note that the first WLANSP rule 311 includes a validity condition. In various embodiments, the UE 205 ignores the validity condition in the first WLANSP rule 311 when the examined WLANSP rule is referenced by an Active URSP rule.

Regarding the second URSP rule 302: The traffic that matches the Traffic Descriptor component of this rule should be transmitted via a PDU Session over non-3GPP access, with type IPV6 and with network slice information S-NSSAI-x. Here, the non-3GPP access network should be selected using the WLANSP rule with Rule identifier=172, i.e., the third WLANSP rule 313. Note that the third WLANSP rule is a lower priority WLANSP, i.e., both the first and second WLANSP rules 311-312 have higher priorities than the third WLANSP rule 313. In various embodiments, the UE 205 ignores the priority of a WLANSP rule when the examined WLANSP rule is referenced by an Active URSP rule.

Regarding the third URSP rule 303: The traffic that matches the Traffic Descriptor component of this rule should be transmitted via a PDU Session over non-3GPP access, with type IPv4 and with data network name DNN-y. Here, the non-3GPP access network should be selected using the WLANSP rule with Rule identifier=101, i.e., the second WLANSP rule 312. Note that the second WLANSP rule 312 includes a validity condition. In various embodiments, the UE 205 ignores the validity condition in the second WLANSP rule 312 when the examined WLANSP rule is referenced by an Active URSP rule.

By updating the URSP rules to reference the WLANSP rules, it becomes feasible to select a WLAN access network based on:
a. What traffic should be transmitted over the WLAN access network (as defined in the Traffic Descriptor component); and
b. What PDU Session should be established over the WLAN access network (as defined in the Route Selection Descriptor component).

For example, if the UE 205 applies a URSP rule which indicates that a PDU Session over non-3GPP access should be established and this PDU Session must use a certain S-NSSAI and/or a certain DNN and/or a certain SSC mode, etc., then the UE 205 will select a WLAN access network by applying a specific WLANSP rule, which contains selection criteria optimized for this scenario.

It is important to note that the URSP rules applicable in a PLMN may contain references only to the WLANSP rules provided by the same PLMN. In the most typical scenario, the URSP rules and the WLANSP rules are both provided by the same operator; hence, the operator can reference its own WLANSP rules from its own URSP rules. However, it is feasible for an operator to provide URSP rule to UE 205 that reference WLANSP rules provided to UE 205 by another operator. This is further explained in the example below.

Assume that a home operator provides to UE 205 a set of URSP rules for a visited PLMN (VPLMN-a), i.e., rules that are applicable when the UE 205 roams to VPLMN-a. These URSP rules may contains references to the WLANSP rules provided to UE 205 by VPLMN-a, which are also applicable when the UE 205 roams to VPLMN-a. The URSP rules for VPLMN-a provided by the home operator can reference the WLANSP rules provided by VPLMN-a, when the home operator has some agreement with the operator of VPLMN-a and knows the WLANSP rules provided by VPLMN-a. When the home operator does not know the WLANSP rules provided by VPLMN-a, then the home operator may provide to UE 205 a set of URSP rules for VPLMN-a, but these URSP rules will not contain references to the WLANSP rules provided by VPLMN-a.

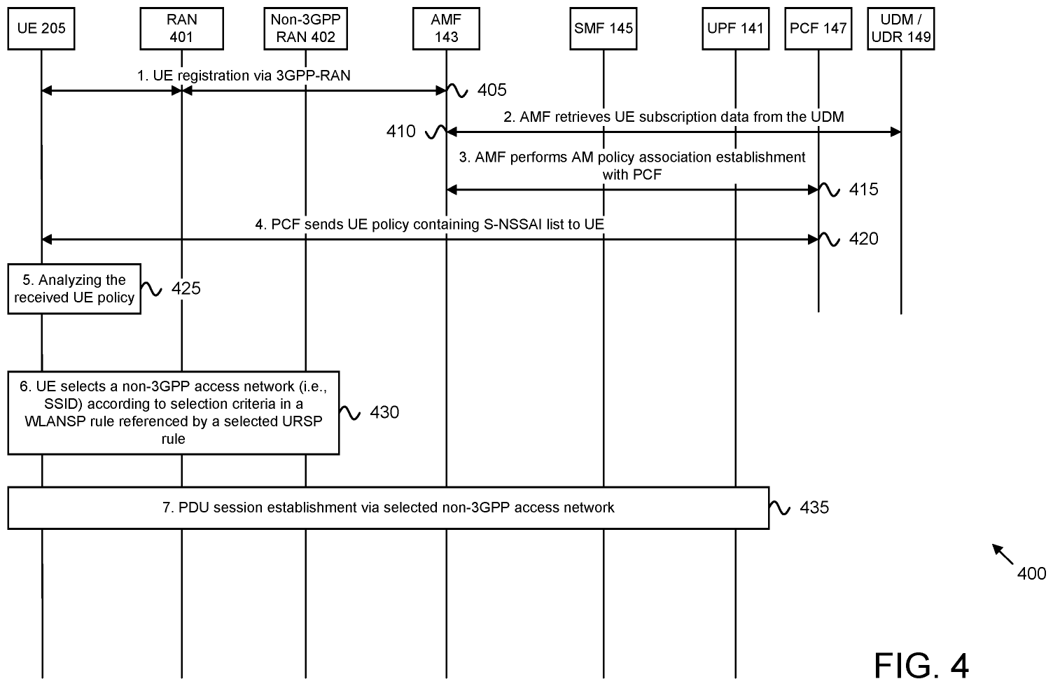

FIG. 4 depicts signaling flow of a procedure 400 for PDU session establishment by using an S-NSSAI while the UE is connected to the non-3GPP network via a specific network slice, according to embodiments of the disclosure. The procedure 400 involves the UE 205, a RAN 401, a Non-3GPP-RAN 402, the AMF 143, the SMF 145, the UPF 141, the PCF 147, and the UDM/UDR 149. Here, the AMF 143, SMF 145, UPF 141, PCF 147, UDM/UDR 149 are network functions in a 5GC, wherein the UE 205 may register with a network slice in the 5GC via the non-3GPP RAN 130.

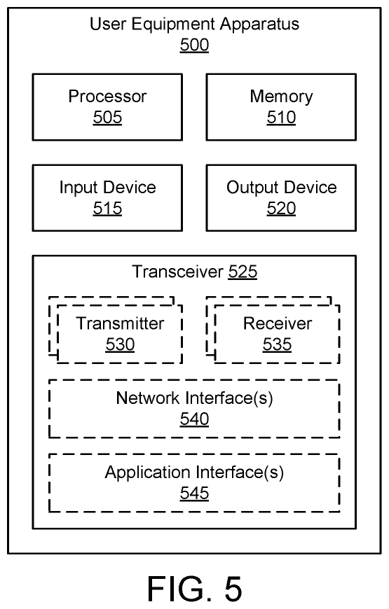

As discussed above, the UE 205 may be provisioned with a URSP containing one or more URSP rules that reference WLANSP rules. A URSP rule whose Traffic Descriptor (“TD”) component matched a data flow may contain a Route Selection Descriptor (“RSD”) component that points to a specific WLANSP rule. The UE 205 analyzes the contents of the URSP to find a valid TD and then selects a WLAN according to the referenced WLANSP rule. The detailed description of the FIG. 5 is as follows:

At Step 1, the UE 205 registers to the 5G System (“5GS”) via the RAN 401 (see block 405). In one embodiment, the RAN 401 is a 3GPP RAN. In other embodiments, the RAN 401 is a non-3GPP RAN.

At Step 2, the Access and Mobility Management Function (“AMF”) 143 may create the UE context and therefore it may retrieve UE subscription data from the UDM/UDR 149 (see block 410). In various embodiments, this UE subscription data includes the access and mobility subscription, Session and Mobility Management Function (“SMF”) selection subscription data, UE context in SMF data and location services (“LCS”) mobile origination for the UE location information, (see, e.g., 3GPP TS 23.502).

At Step 3, based on the local policy, the AMF 143 may perform access and mobility management (“AM”) policy association establishment by sending to the Policy Control Function (“PCF”) 147 information about the serving network (see block 415). Said information about the serving network may be in form of Subscription Permanent Identifier (“SUPI”), subscription notification indication and Service Area Restrictions, the Allowed NSSAI, Access Type and RAT Type, Permanent Equipment Identifier (“PEI”), UE time zone and Serving Network's PLMN ID, or PLMN ID/Network Identifier (“NID”), see, e.g., 3GPP TS 23.501 and 3GPP TS 23.502.

At Step 4, the PCF 147 retrieves the UE policy information and transmits that towards the UE 205 via the AMF 143 with the content of the UE policy information being transparent to the AMF 143 (see block 420). According to embodiments of the disclosure, the UE policy comprises URSP rules and WLANSP rules, where a URSP rule comprises a TD component and an RSD component that references a WLANSP rule.

Note that the UE 205 may send information to the PCF 147 about the preconfigured PLMNs. Here, the information about the preconfigured PLMNs may be in the form of a UE Policy Section Identifier (“UPSI”) list, e.g., as defined in Annex D of 3GPP TS 24.501.

At Step 5, the UE 205 analyzes the received policies and may use the information in the WLANSP by collecting one or more SSIDs (see block 425).

At Step 6, at a later time the UE 205 may use the collection and policy rules from the previous steps to choose an SSID according to WLANSP selection criteria for transferring traffic matching a TD component of a selected (i.e., Active) URSP rule (see block 430). Where the WLANSP selection criteria is based on WLAN AN capabilities, the UE 205 may use ANQP procedure to discover suitable SSIDs.

At Step 7, the UE 205 establishes a data connection via a chosen WLAN access network (SSID) according to parameters in an RSD component of the selected URSP rule (see block 435).

In one embodiment, the UE 205 may use the chosen WLAN access network to register with a PLMN and establish a PDU session, e.g., via a particular network slice (S-NSSAI) according to the RSD component. In another embodiment, the UE 205 may use the chosen WLAN access network to establish a direct offload connection according to the RSD component.

FIG. 5 depicts a user equipment apparatus 500 that may be used for WLAN access network selection, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panel supporting one or more beams. Additionally, the transceiver 525 may support at least one network interface 540 and/or application interface 545. The application interface(s) 545 may support one or more APIs. The network interface(s) 540 may support 3GPP reference points, such as NWt, NWu, Uu, N1, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 identifies a first data flow that matches a first URSP rule, where the first URSP rule indicates that the first data flow is to be transmitted over a N3AN. Here, the first URSP rule contains a reference to a first WLANSP rule. The processor 505 selects a first N3AN by applying the first WLANSP rule. The processor 505 controls the transceiver 525 to transmit the first data flow via the selected N3AN. In further embodiments, the processor 505 may register the UE with the mobile communication network over the selected N3AN prior to transmitting the first data flow via the selected N3AN.

In some embodiments, the URSP contains a TD component used to identify the first data flow and an RSD component. The TD component contains at least one attribute (e.g., application identity, connection capabilities, etc.) used to identity the first data flow. The RSD component indicates how to transfer the first data flow over the N3AN (e.g., directly via the non-3GPP access or via a PDU Session).

The RSD component contains the reference to the first WLANSP rule. In certain embodiments, the RSD component further includes an offload indication (i.e., “non-seamless non-3GPP offload indication”) indicating that the first data flow is to be routed directly through the selected N3AN without using a PDU session in the mobile communication network. In certain embodiments, the RSD component further includes at least one connectivity parameter indicating that the first data flow is to be routed through a PDU session in a mobile communication network. Here, the at least one connectivity parameter may include one or more PDU Session parameters, such as a DNN, a S-NSSAI, a PDU type, etc.

In certain embodiments, the processor 505 applies the first WLANSP rule (i.e., to select the N3AN) by: 1) deciding to select a trusted N3AN in response to the RSD component containing at least one connectivity parameter; 2) identifying a first set of N3ANs that support 5G connectivity with the mobile communication network; and 3) applying the first WLANSP rule to select a N3AN from the first set of N3ANs.

In certain embodiments, the processor 505 transmits the first data flow via the selected N3 AN by: 1) registering with the mobile communication network via the selected N3AN; 2) establishing a PDU session with the mobile communication network via the selected N3AN using the at least one connectivity parameter; and 3) transmitting the first data flow over the PDU session. Note that these steps are applicable when the first URSP rule contains either an access type preference equal to non-3GPP or a multi-access preference (in which case a PDU session is required). However, when the first URSP rule contains a non-seamless non-3GPP offload indication, then the processor 505 does not register with the mobile network via the non-3GPP access and does not establish a PDU session via the non-3GPP access.

In some embodiments, the first WLANSP rule includes a set of validity conditions. In such embodiments, selecting a N3 AN by applying the first WLANSP rule may include ignoring the validity conditions in response to the first URSP rule containing the reference to the first WLANSP rule. In some embodiments, the URSP rule is received from a first mobile communication network and the first WLANSP rule are received from a second mobile communication network. In certain embodiments, the first and second mobile communication networks are different networks. For example, the first mobile communication network may be the home network of the user equipment apparatus 500, while the second mobile communication network may be a visited network. In other embodiments, the first and second mobile communication networks are the same network.

In some embodiments, the first URSP rule indicates that the first data flow is to be transmitted over a N3AN by containing: A) an access type preference equal to non-3GPP access; B) a multi-access preference indication; and/or C) a non-seamless non-3GPP offload indication. Note that the non-seamless non-3GPP offload indication is an indication that does not have a value. Similarly, the multi-access preference indication is an indication that does not have a value. When present, this indication indicates that the first data flow is to be transmitted on a multi-access PUD session using both 3GPP and non-3GPP access networks.

In some embodiments, selecting a N3AN by applying the first WLANSP rule includes selecting a N3AN from the set of available N3ANs and skipping (i.e., bypassing) the registration with the mobile communication network via the selected N3AN in response to the RSD component containing an offload indication. Note that with the offload indication, the UE does not care whether the N3AN is trusted or untrusted.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to mobile operation. For example, the memory 510 may store various parameters, configurations, resource assignments, policies, and the like as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

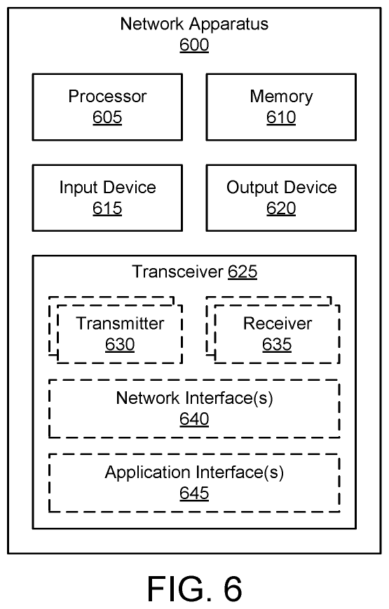

FIG. 6 depicts a network apparatus 600 that may be used for WLAN access network selection, according to embodiments of the disclosure. In one embodiment, network apparatus 600 may be one implementation of an access management function in a mobile communication network, such as the AMF 143, described above. Furthermore, the network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as NWu, Uu, N1, N2, N3, N4, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. When implementing a RAN node, the processor 605 may include an application processor (also known as “main processor”) which manages application-domain and operating system (“OS”) functions and a baseband processor (also known as “baseband radio processor”) which manages radio functions.

In various embodiments, the processor 605 controls the network apparatus 600 to implement the above described PCF behaviors. For example, via the network interface 640 the processor 605 may send a UE policy to a remote unit 105, where the UE policy includes at least one URSP rule that references a WLANSP rule.

In various embodiments, the processor 605 controls the network apparatus 600 to implement the above described N3AN behaviors. For example, via the transceiver 625 the processor 605 may receive a request to register with a mobile communication network using a first slice, e.g., identified by a first S-NSSAI, and perform a registration procedure. Additionally, the processor 605 may receive (e.g., via the transceiver 625) a request to establish a data connection with the first network slice (e.g., a PDU Session Establishment request containing the first S-NSSAI) and perform a data connection establishment procedure (e.g., PDU Session Establishment procedure).

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to WLAN access network selection. For example, the memory 610 may store parameters, configurations, resource assignments, policies, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein.

Similarly, one or more receivers 635 may be used to communicate with network functions in the core network (e.g., 5GC, EPC) and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

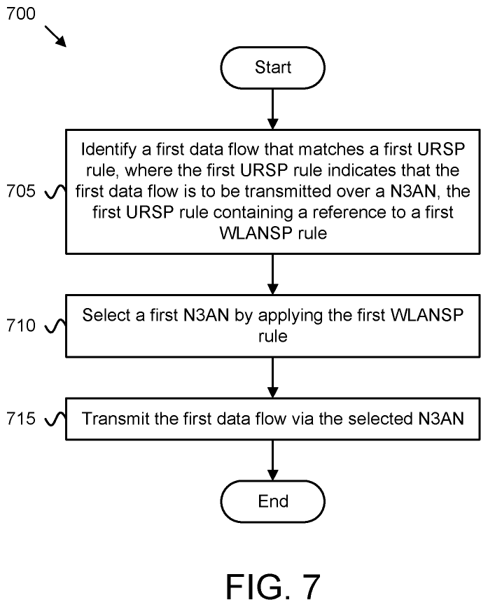

FIG. 7 depicts one embodiment of a method 700 for WLAN access network selection, according to embodiments of the disclosure. In various embodiments, the method 700 is performed by a user equipment device in a mobile communication network, such as the remote unit 105, the UE 205, and/or the user equipment apparatus 500, described above. In some embodiments, the method 700 is performed by a processor, such as a microcontroller, a microprocessor, a CPU, a GPU, an auxiliary processing unit, a FPGA, or the like.

The method 700 begins and identifies 705 a first data flow that matches a first URSP rule. Here, the first URSP rule indicates that the first data flow is to be transmitted over a N3AN, the first URSP rule containing a reference to a first WLANSP rule. The method includes selecting 710 a first N3AN by applying the first WLANSP rule. The method 700 includes transmitting 715 the first data flow via the selected N3AN. The method 700 ends.

Disclosed herein is a first apparatus for WLAN access network selection, according to embodiments of the disclosure. The first apparatus may be implemented by a user equipment device in a mobile communication network, such as the remote unit 105, the UE 205, and/or the user equipment apparatus 500, described above. The first apparatus includes a transceiver and a processor that a processor that identifies a first data flow that matches a first URSP rule. Here, the first URSP rule indicates that the first data flow is to be transmitted over a N3AN, where the first URSP rule contains a reference to a first rule. The processor selects a first N3AN by applying the first WLANSP rule and controls the transceiver to transmit the first data flow via the selected N3AN.

In some embodiments, the URSP contains a traffic descriptor component used to identify the first data flow and an RSD component, wherein the RSD component contains the reference to the first WLANSP rule. In certain embodiments, the RSD component further includes an offload indication (i.e., “non-seamless non-3GPP offload indication”) indicating that the first data flow is to be routed directly through the selected N3AN without using a PDU session in the mobile communication network.

In certain embodiments, the RSD component further includes at least one connectivity parameter indicating that the first data flow is to be routed through a PDU session in a mobile communication network. Here, the at least one connectivity parameter may include one or more PDU Session parameters, such as a DNN, a S-NSSAI, a PDU type, etc. In further embodiments, the processor may register the UE with the mobile communication network over the selected N3AN.

In certain embodiments, selecting a N3AN by applying the first WLANSP rule comprises: deciding to select a trusted N3AN in response to the RSD component containing at least one connectivity parameter, identifying a first set of N3ANs that support 5G connectivity with the mobile communication network, and applying the first WLANSP rule to select a N3AN from the first set of N3ANs. In certain embodiments, transmitting the first data flow via the selected N3AN comprises: registering with the mobile communication network via the selected N3AN, establishing a PDU session with the mobile communication network via the selected N3AN using the at least one connectivity parameter, and transmitting the first data flow over the PDU session.

In some embodiments, the first WLANSP rule includes a set of validity conditions. In such embodiments, selecting a N3 AN by applying the first WLANSP rule may include ignoring the validity conditions in response to the first URSP rule containing the reference to the first WLANSP rule. In some embodiments, the URSP rule is received from a first mobile communication network and the WLANSP rules are received from a second mobile communication network.

In some embodiments, the first URSP rule indicates that the first data flow is to be transmitted over a N3AN by containing: A) an access type preference equal to non-3GPP access; B) a multi-access preference indication; and/or C) a non-seamless non-3GPP offload indication. In some embodiments, selecting a N3AN by applying the first WLANSP rule includes selecting a N3AN from the set of available N3ANS and skipping the registration with the mobile communication network via the selected N3AN in response to the RSD component containing an offload indication (i.e., “non-seamless non-3GPP offload indication”).

Disclosed herein is a first method for WLAN access network selection, according to embodiments of the disclosure. The first method may be performed by a user equipment device in a mobile communication network, such as the remote unit 105, the UE 205, and/or the user equipment apparatus 500. The first method includes identifying a first data flow that matches a first URSP rule. Here, the first URSP rule indicates that the first data flow is to be transmitted over a N3AN, the first URSP rule containing a reference to a first WLANSP rule. The method includes selecting a first N3AN by applying the first WLANSP rule and transmitting the first data flow via the selected N3 AN.

In some embodiments, the URSP contains a traffic descriptor component used to identify the first data flow and an RSD component, wherein the RSD component contains the reference to the first WLANSP rule. In certain embodiments, the RSD component further includes an offload indication (i.e., “non-seamless non-3GPP offload indication”) indicating that the first data flow is to be routed directly through the selected N3AN without using a PDU session in the mobile communication network.

In certain embodiments, the RSD component further includes at least one connectivity parameter indicating that the first data flow is to be routed through a PDU session in a mobile communication network. Here, the at least one connectivity parameter may include one or more PDU Session parameters, such as a DNN, a S-NSSAI, a PDU type, etc. In further embodiments, the first method may include registering with the mobile communication network over the selected N3AN.

In certain embodiments, selecting a N3AN by applying the first WLANSP rule comprises: deciding to select a trusted N3AN in response to the RSD component containing at least one connectivity parameter, identifying a first set of N3ANs that support 5G connectivity with the mobile communication network, and applying the first WLANSP rule to select a N3AN from the first set of N3ANs. In certain embodiments, transmitting the first data flow via the selected N3AN comprises: registering with the mobile communication network via the selected N3AN, establishing a PDU session with the mobile communication network via the selected N3AN using the at least one connectivity parameter, and transmitting the first data flow over the PDU session.

In some embodiments, the first WLANSP rule includes a set of validity conditions. In such embodiments, selecting a N3AN by applying the first WLANSP rule may include ignoring the validity conditions in response to the first URSP rule containing the reference to the first WLANSP rule. In some embodiments, the URSP rule is received from a first mobile communication network and the WLANSP rules are received from a second mobile communication network.

In some embodiments, the first URSP rule indicates that the first data flow is to be transmitted over a N3AN by containing: A) an access type preference equal to non-3GPP access; B) a multi-access preference indication; and/or C) a non-seamless non-3GPP offload indication. In some embodiments, selecting a N3AN by applying the first WLANSP rule includes selecting a N3AN from the set of available N3ANS and skipping the registration with the mobile communication network via the selected N3AN in response to the RSD component containing an offload indication (i.e., “non-seamless non-3GPP offload indication”).

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) for wireless communication, comprising:
at least one memory; and
at least one processor coupled with the at least one memory and configured to cause the UE to:
identify a first data flow that matches a first UE Route Selection Policy (“URSP”) rule, wherein the first URSP rule indicates that the first data flow is to be transmitted over a non-3GPP access network (“N3AN”), the first URSP rule comprising a reference to a first Wireless Local Area Network Selection Policy (“WLANSP”) rule; and
select a first N3AN by applying the first WLANSP rule; and
transmit the first data flow via the selected N3AN.

2. The UE of claim 1, wherein the URSP comprises a traffic descriptor component used to identify the first data flow and a route selection description (“RSD”) component, wherein the RSD component comprises the reference to the first WLANSP rule.

3. The UE of claim 2, wherein the RSD component further includes at least one connectivity parameter indicating that the first data flow is to be routed through a Packet Data Unit (“PDU”) session in a mobile communication network, wherein the at least one processor is configured to cause the UE to register with the mobile communication network over the selected N3AN.

4. The UE of claim 3, wherein to select a N3AN by applying the first WLANSP rule, the at least one processor is configured to cause the UE to:
decide to select a trusted N3AN in response to the RSD component comprising at least one connectivity parameter;
identify a first set of N3ANs that support 5G connectivity with the mobile communication network; and
apply the first WLANSP rule to select a N3AN from the first set of N3ANS.

5. The UE of claim 3, wherein to transmit the first data flow via the selected N3AN, the at least one processor is configured to cause the UE to:
register with the mobile communication network via the selected N3AN;
establish a PDU session with the mobile communication network via the selected N3AN using the at least one connectivity parameter; and
transmit the first data flow over the PDU session.

6. The UE of claim 2, wherein the RSD component further includes an offload indication indicating that the first data flow is to be routed directly through the selected N3AN without using a Packet Data Unit (“PDU”) session in a mobile communication network.

7. The UE of claim 1, wherein the first WLANSP rule includes a set of validity conditions, and wherein to select a N3AN by applying the first WLANSP rule, the at least one processor is configured to cause the UE to ignore the validity conditions in response to the first URSP rule comprising the reference to the first WLANSP rule.

8. The UE of claim 1, wherein to indicate that the first data flow is to be transmitted over a N3AN, the first URSP rule comprises one or more of:
an access type preference equal to non-3GPP access;
a multi-access preference indication;
a non-seamless non-3GPP offload indication;
or a combination thereof.

9. The UE of claim 2, wherein to select a N3AN by applying the first WLANSP rule, the at least one processor is configured to cause the UE to:
apply the first WLANSP rule to select a N3AN from a set of available N3ANs; and
skip a registration with a mobile communication network via the selected N3AN in response to the RSD component comprising an offload indication.

10. The UE of claim 1, wherein the URSP rule is received from a first mobile communication network and the WLANSP rules are received from a second mobile communication network.

11. A processor for wireless communication, comprising:
at least one controller coupled with at least one memory and configured to cause the processor to:
identify a first data flow that matches a first UE Route Selection Policy (“URSP”) rule, wherein the first URSP rule indicates that the first data flow is to be transmitted over a non-3GPP access network (“N3AN”), the first URSP rule comprising a reference to a first Wireless Local Area Network Selection Policy (“WLANSP”) rule;
select first N3AN by applying the first WLANSP rule; and
transmit the first data flow via the selected N3AN.

12. The processor of claim 11, wherein the URSP comprises a traffic descriptor component used to identify the first data flow and a route selection description (“RSD”) component, wherein the RSD component comprises the reference to the first WLANSP rule.

13. The processor of claim 12, wherein the RSD component further includes at least one connectivity parameter indicating that the first data flow is to be routed through a Packet Data Unit (“PDU”) session in a mobile communication network, wherein the at least one controller is configured to cause the processor to register with the mobile communication network over the selected N3AN.

14. The processor of claim 13, wherein to select a N3AN by applying the first WLANSP rule, the at least one controller is configured to cause the processor to:
decide to select a trusted N3AN in response to the RSD component comprising at least one connectivity parameter;
identify a first set of N3ANs that support 5G connectivity with the mobile communication network; and
apply the first WLANSP rule to select a N3AN from the first set of N3Ans.

15. The processor of claim 13, wherein to transmit the first data flow via the selected N3AN, the at least one controller is configured to cause the processor to:
register with the mobile communication network via the selected N3AN;
establish a PDU session with the mobile communication network via the selected N3AN using the at least one connectivity parameter; and
transmit the first data flow over the PDU session.

16. The processor of claim 12, wherein the RSD component further includes an offload indication indicating that the first data flow is to be routed directly through the selected N3AN without using a Packet Data Unit (“PDU”) session in a mobile communication network.

17. The processor of claim 11, wherein the first WLANSP rule includes a set of validity conditions, and wherein to select a N3AN by applying the first WLANSP rule, the at least one controller is configured to cause the processor to ignore the validity conditions in response to the first URSP rule comprising the reference to the first WLANSP rule.

18. The processor of claim 11, wherein to indicate that the first data flow is to be transmitted over a N3AN, the first URSP rule comprises one or more of:
an access type preference equal to non-3GPP access;
a multi-access preference indication;
a non-seamless non-3GPP offload indication;
or a combination thereof.

19. The processor of claim 12, wherein to select a N3AN by applying the first WLANSP rule, the at least one controller is configured to cause the processor to:
apply the first WLANSP rule to select a N3AN from a set of available N3ANs; and
skip a registration with a mobile communication network via the selected N3AN in response to the RSD component comprising an offload indication.

20. The processor of claim 11, wherein the URSP rule is received from a first mobile communication network and the WLANSP rules are received from a second mobile communication network.
